(19) United States
(12) Patent Application Publication
(10) Pub. No.: US 2010/0088734 A1
(43) Pub. Date: Apr. 8, 2010

(54) RECEPTION APPARATUS, RECEPTION METHOD, AND SERVER APPARATUS

(76) Inventors: Yoshiharu DEWA, Tokyo (JP); Tetsunori Ito, Kanagawa (JP); Katsunori Hashimoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/575,249

(22) Filed: Oct. 7, 2009

(30) Foreign Application Priority Data
Oct. 8, 2008 (JP) P2008-262003

(51) Int. Cl. H04N 7/173

(52) U.S. Cl. 725/93; 725/100

(57) ABSTRACT

A reception apparatus includes an acquisition section and a transmission section. The acquisition section acquires program information containing an ID that is assigned to a broadcast program by a broadcaster and a broadcast date and time. The transmission section transmits, to a server apparatus that manages the broadcast program using identification information formed by combination of the ID and the broadcast date and time, a request containing the identification information formed by combination of the ID and the broadcast date and time that are contained in the program information.

### BACKGROUND OF THE INVENTION

1. Field of the Invention

The present invention relates to a reception apparatus and a reception method for receiving data of a program that is broadcast and delivered and data of a program delivered by VOD (Video On Demand), and a server apparatus that delivers data of a program by VOD.

2. Description of the Related Art

Program sequence information (SI: Service Information) in digital broadcasting of Japan includes information delivered at 0 o'clock regularly (all-station SI) and more detailed information delivered when a program is actually viewed (each-station SI).

The all-station SI includes general program information such as “program name” and “broadcast time”, and the each-station SI includes detailed information such as “notification”, “program information”, “actor”, “original/screenplay”, “director”, “music”, and “producer”. It should be noted that the all-station SI is operated only in BS (Broadcasting Satellite) digital broadcasting at the present moment.

A television program is broadcast according to the SI created by a broadcaster. A viewer retrieves a desired program from the SI or sets a start timing of recording based on the SI in order to make a recording reservation on a recording apparatus.

On the other hand, video delivery using the Internet is prevalent. The video delivery using the Internet is in a form of VOD in which a content delivery provider arranges video contents procured from a broadcaster on a server and delivers the video contents in response to a request from a user terminal connected to the Internet.

### SUMMARY OF THE INVENTION

In addition, as a form of a service in which the digital broadcasting and the video delivery using the Internet are linked with each other, the following mode has been studied recently. During viewing of a program by digital broadcasting, information is presented to a viewer, the information indicating that programs related to the program currently viewed can be viewed by VOD. As premises for this, a broadcaster provides data of the programs related to the broadcast program to a content delivery provider in advance. When a viewer selects one of the related programs for viewing, a request is transmitted to a server of the content delivery provider from a terminal of the viewer and then a video content of the related program is delivered to the terminal of the viewer.

However, under present circumstances, there is no correlation between the SI supplied by the broadcaster and information for identifying contents managed on the server of the content delivery provider, and therefore the terminal of the viewer cannot specify the contents managed by the content delivery provider.

In this regard, when attention is focused on an event ID used to manage broadcast programs by the broadcaster, it is conceivable that the event ID is also used on the server of the content delivery provider to manage programs. In other words, an event ID of the related program is added to the SI and is transmitted to the terminal of the viewer. The terminal of the viewer uses the event ID of the related program to inquire a URL (Uniform Resource Locator) that specifies a content in question from the server of the content delivery provider. The terminal of the viewer transmits a VOD request for the content in question using the acquired URL.

However, since the number of digits of the event ID assigned to a program by the broadcaster is fixed, kinds of unique event IDs assigned to programs are limited. Therefore, assuming a long operation period, it is anticipated that the same event ID will be eventually given to a plurality of different programs because of depletion of event IDs. For example, in a case where a broadcast program is a rebroadcast program of a program that has been broadcast before, an event ID of the program related to the broadcast program may have been assigned in a past event-ID-assignment-cycle. For that reason, there may occur a situation in which contents of a plurality of programs to which the same event ID is assigned are stored in the server of the content delivery provider, resulting in failure of the system in which programs are managed by event IDs also in the server of the content delivery provider.

As another method, it is conceivable that a URL of a related program is embedded in the SI. However, in a case of adopting this method, it is necessary for the content delivery provider to notify the URL to the broadcaster, resulting in an increased load on the broadcaster and the content delivery provider. Besides, it is necessary to largely change a transmission apparatus, for example, a function of embedding the URL of the related program in the SI is installed in a transmission apparatus of the broadcaster.

In view of the circumstances as described above, there is a need for a reception apparatus, a reception method, and a server apparatus that are capable of identifying infinite kinds of broadcast programs in the server apparatus and the reception apparatus even if kinds of IDs assigned to the broadcast programs by a broadcaster are finite, and maintaining correlation between identification information of a broadcast program that is broadcast and delivered and identification information of a broadcast program delivered by VOD.

According to an embodiment of the present invention, there is provided a reception apparatus including: an acquisition section to acquire program information containing an ID that is assigned to a broadcast program by a broadcaster and a broadcast date and time; and a transmission section to transmit, to a server apparatus that manages the broadcast program using identification information formed by combination of the ID and the broadcast date and time, a request containing the identification information formed by combination of the ID and the broadcast date and time that are contained in the program information. Here, examples of the program information include program sequence information containing information such as an ID and a broadcast date and time of a broadcast program, and related-program information containing information such as an ID and a broadcast date and time of a program related to a broadcast program.

In the embodiment of the present invention, by transmitting to the server apparatus the request containing the identification information formed by combination of the ID that is assigned by the broadcaster to each broadcast program and the broadcast date and time, the ID and the broadcast date and time being contained in the program information, it is possible to identify infinite kinds of broadcast programs in the server apparatus and the reception apparatus even if kinds of IDs assigned to the broadcast programs by the broadcaster are finite, with the result that correlation between identification information of a broadcast program that is broadcast and delivered and identification information of a broadcast program delivered by VOD can be maintained.

The reception apparatus according to the embodiment of the present invention further includes a selection section to cause a user to select a broadcast program as a request target based on the program information, and the transmission section takes out the ID and the broadcast date and time of the selected broadcast program from the program information and transmits to the server apparatus a request containing the identification information formed by combination of the ID and the broadcast date and time. Accordingly, it is possible to specify, with respect to the server apparatus, the broadcast program as a request target that is selected by the user in the reception apparatus, using the identification information formed by combination of the ID that is assigned by the broadcaster and the broadcast date and time.

In the reception apparatus according to the embodiment of the present invention, the transmission section may transmit, to the server apparatus, the request for acquiring information that specifies content data of the selected broadcast program.

In the reception apparatus according to the embodiment of the present invention, the transmission section may transmit, to the server apparatus, the request for specifying content data of a program related to a broadcast program being received.

According to another embodiment of the present invention, there is provided a reception method including: acquiring program information containing an ID that is assigned to a broadcast program by a broadcaster and a broadcast date and time; and transmitting, to a server apparatus that manages the broadcast program using identification information formed by combination of the ID and the broadcast date and time, a request containing the identification information formed by combination of the ID and the broadcast date and time that are contained in the program information.

According to still another embodiment of the present invention, there is provided a server apparatus including: a database section to register identification information that identifies a broadcast program and program-data specific information that specifies content data of the broadcast program in association with each other, the identification information being formed by combination of an ID that is assigned to the broadcast program by a broadcaster and a broadcast date and time; and a request processing section to retrieve, when a request containing the identification information is received from a reception apparatus, the program-data specific information associated with the identification information contained in the request from the database section, and returns the program-data specific information to the reception apparatus.

According to still another embodiment of the present invention, there is provided a server apparatus including: a database section to register first identification information that identifies a broadcast program, second identification information that identifies a broadcast program related to the broadcast program as a related program, and program-data specific information that specifies content data of the broadcast program in association with one another, the first identification information being formed by combination of an ID that is assigned by a broadcaster to the broadcast program and a broadcast date and time, the second identification information being formed by combination of an ID that is assigned by the broadcaster to the related program and a broadcast date and time; and a request processing section to retrieve, when a request containing the first identification information of the broadcast program is received from a reception apparatus, the second identification information of the related program from the database section, the second identification information being associated with the first identification information contained in the request, retrieves the broadcast program whose first identification information coincides with the retrieved second identification information, and returns the program-data specific information associated with the broadcast program to the reception apparatus.

As described above, according to the embodiments of the present invention, even if kinds of IDs assigned to broadcast programs by a broadcaster are finite, it is possible to identify infinite kinds of broadcast programs in the server apparatus and the reception apparatus, and to maintain correlation between identification information of a broadcast program that is broadcast and delivered and identification information of a broadcast program delivered by VOD.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a structure of a content delivery system according to a first embodiment of the present invention;

FIG. 2 is a diagram showing a hardware structure of a reception apparatus of FIG. 1;

FIG. 3 is a block diagram showing a hardware structure of a content delivery server and a web server of FIG. 1;

FIG. 4 is a sequence diagram showing a processing flow in the content delivery system according to the first embodiment of the present invention;

FIG. 5 is a diagram showing an example of information registered in a database;

FIG. 6 is a diagram showing a display example of a broadcast program and a list of related programs;

FIG. 7 is a diagram showing a first modified example of the first embodiment;

FIG. 8 is a diagram showing a structure of a content delivery system according to a second embodiment of the present invention;

FIG. 9 is a sequence diagram showing a processing flow in the content delivery system according to the second embodiment of the present invention;

FIG. 10 is a diagram showing a second modified example of the first embodiment;

FIG. 11 is a diagram showing the second modified example of the second embodiment; and

FIG. 12 is a diagram showing a third modified example of the first embodiment.

### DESCRIPTION OF PREFERRED EMBODIMENTS

Hereinafter, embodiments of the present invention will be described with reference to the drawings.

### First Embodiment

### Structure of Content Delivery System

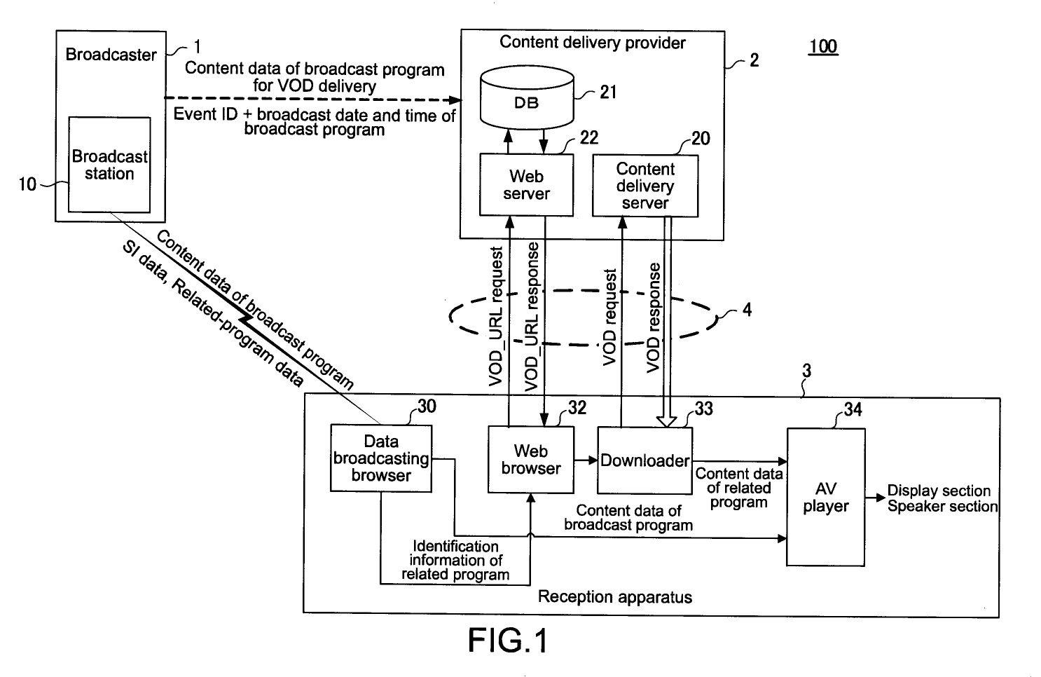

FIG. 1 is a diagram showing a structure of a content delivery system according to a first embodiment of the present invention.

As shown in FIG. 1, a content delivery system 100 includes a broadcaster 1, a content delivery provider 2, and a reception apparatus 3. Specifically, the reception apparatus 3 is computer equipment such as a PC (Personal Computer), a television receiver, a cellular phone, a PDA (Personal Digital Assistant), a recording apparatus, or the like.

The broadcaster 1 has a broadcast station 10. For example, the broadcast station 10 broadcasts and delivers content data of a program in a broadcast mode such as Digital terrestrial television broadcasting, CS digital broadcasting, and BS digital broadcasting. The broadcast station 10 delivers by data broadcasting, in addition to content data of a broadcast program, SI (Service Information) data containing information such as a title, an event ID, and a broadcast date and time of the broadcast program, and related-program data such as a title, an event ID, and a broadcast date and time of a broadcast program related to the aforementioned broadcast program (related program). Further, the broadcaster 1 provides the content delivery provider 2 with, in addition to content data of a broadcast program for VOD (Video On Demand) delivery, a list in which correlation between a broadcast program and a broadcast program related thereto (hereinafter, referred to as “broadcast program (related program)”) is described based on identification information formed by combination of the event ID and the broadcast date and time (date and time of broadcast start/end) of each of the broadcast programs, using a predetermined transmission medium.

The content delivery provider 2 has a content delivery server 20, a database (DB) 21, and a web server 22.

The content delivery server 20 accumulates the content data of the broadcast program, which is supplied by the broadcaster 1, and delivers the accumulated content data of the broadcast program in response to a VOD request transmitted from the reception apparatus 3.

The database (DB) 21 registers the identification information (first identification information) of the broadcast program supplied by the broadcaster 1, the identification information (second identification information) of the broadcast program (related program) related to the aforementioned broadcast program, and a URL (Uniform Resource Locators) (program-data specific information) that specifies a location of a broadcast program in association with one another.

In response to a VOD_URL request containing the identification information of the broadcast program (related program) transmitted from the reception apparatus 3, the web server 22 retrieves a URL of the broadcast program (related program) in question from the database (DB) 21 and transmits it as a VOD_URL response to the reception apparatus 3.

The reception apparatus 3 has a data broadcast browser 30, a web browser 32, a downloader 33, and an AV player 34.

The data broadcast browser 30 receives the content data of the broadcast program that is broadcast and delivered from the broadcast station 10 and supplies it to the AV player 34. Further, the data broadcast browser 30 receives the SI data and the related-program data that are delivered from the broadcast station 10 by data broadcasting, and based on the related-program data, reproduces a list of broadcast programs (related programs) related to the broadcast program being received. Moreover, the data broadcast browser 30 supplies, to the web browser 32, identification information formed by combination of an event ID and a broadcast date and time of a broadcast program (related program) selected by a user from the list of the broadcast programs (related programs).

Based on the identification information of the broadcast program (related program) provided by the data broadcast browser 30, the web browser 32 inquires a URL that specifies a location of content data of the broadcast program (related program) from the web server 22 of the content delivery provider 2 via a network 4. Then, the web browser 32 notifies the acquired URL to the downloader 33.

The downloader 33 transmits a VOD request containing the URL notified by the web browser 32 to the content delivery server 20 and supplies content data of the broadcast program (related program), the content data being received as a response for the VOD request, to the AV player 34.

The AV player 34 performs processing for reproduction of a video and an audio, such as decoding of the content data of the broadcast program, the content data being supplied from the data broadcast browser 30 or the downloader 33.

Next, a hardware structure of the reception apparatus 3 will be described.

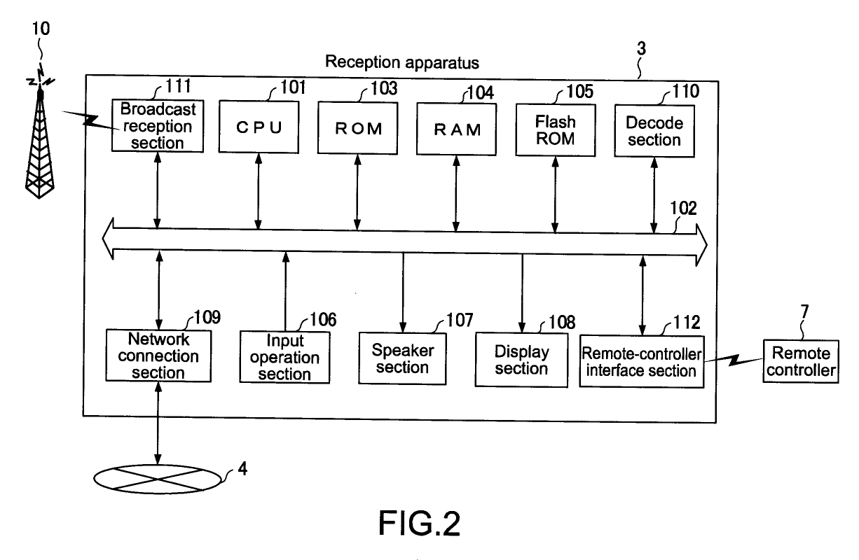

FIG. 2 is a diagram showing the hardware structure of the reception apparatus 3. Here, a case where the reception apparatus 3 is a television receiver will be described.

As shown in FIG. 2, connected to a CPU 101 via a system bus 102 are a ROM 103, a RAM 104, a flash ROM 105, an input operation section 106, a speaker section 107, a display section 108, a network connection section 109, a decode section 110, a broadcast reception section 111, a remote-controller interface section 112, and the like.

The ROM 103 and the flash ROM 105 store programs and various pieces of data processed and executed by the CPU 101. The flash ROM 105 can save various pieces of data. The RAM 104 is used as a temporal working area of the CPU 101 and an area for temporarily saving data.

The input operation section 106 includes various kinds of keys and the like and processes inputs of commands for various operations from a user. A command that is input from the input operation section 106 is sent to the CPU 101 via the system bus 102.

The remote-controller interface section 112 is an interface that performs communication with a remote controller 7. The remote controller 7 includes various kinds of keys as in the input operation section 106, processes inputs of commands for various operations from the user, and converts the inputs into optical signals for transmission. The remote-controller interface section 112 receives the optical signals transmitted from the remote controller 7 and converts the optical signals into electrical signals to output them to the CPU 101 via the system bus 102.

The speaker section 107 outputs an audio of a broadcast program. The display section 108 displays a video of a broadcast program and character information such as a list of broadcast programs (related programs).

The network connection section 109 is, for example, an interface that processes connection with the network 4 such as the Internet.

The broadcast reception section 111 receives airwaves delivered from the broadcast station 10, such as Digital terrestrial television broadcasting, CS digital broadcasting, BS digital broadcasting, and the like, and demodulates video signals and audio signals.

The decode section 110 decodes content data of a broadcast program that has been subjected to compression coding. Video data of the broadcast program restored through the decoding by the decode section 110 is output to the display section 108, and audio data similarly restored through the decoding by the decode section 110 is output to the speaker section 107.

Next, a hardware structure of each of the content delivery server 20 and the web server 22 of the content delivery provider 2 will be described.

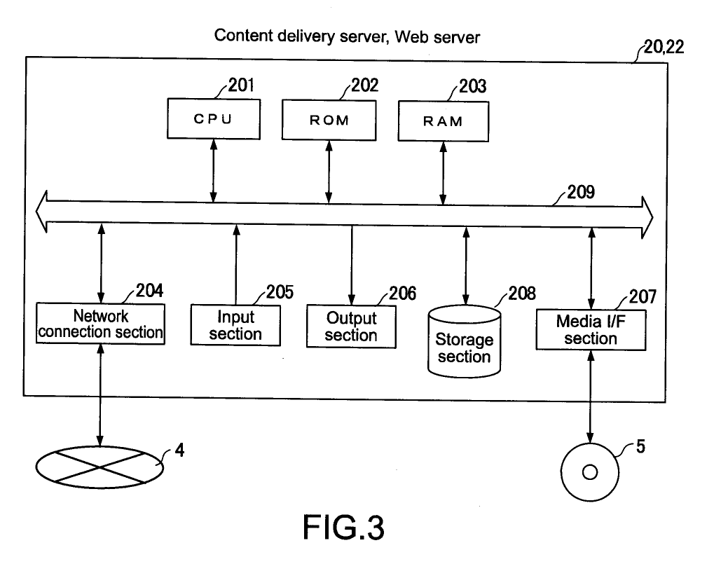

FIG. 3 is a block diagram showing the hardware structure of each of the content delivery server 20 and the web server 22.

As shown in FIG. 3, each of the content delivery server 20 and the web server 22 is structured by a computer system such as a PC.

In other words, connected to a CPU 201 via a system bus 209 are a ROM 202, a RAM 203, a network connection section 204, an input section 205 including a keyboard, a mouse, and the like, an output section 206 including a display such as a CRT (Cathode Ray Tube) and an LCD (Liquid Crystal Display) and a speaker, a media I/F section 207, and a storage section 208 including a hard disc drive and a nonvolatile memory.

The network connection section 204 processes wired or wireless connection with the network 4 such as the Internet. The storage section 208 stores programs, data, and the like causing a computer to execute a function as a specific server. The CPU 201 loads the programs from the ROM 202 or the storage section 208 to the RAM 203 and performs computing for interpretive execution. To the media I/F section 207, a removal medium 5 such as a magnetic disc, an optical disc, and a flash memory is appropriately mounted, and programs read therefrom are installed in the storage section 208 as appropriate.

(Description of Operation)

Next, the content delivery system 100 according to the first embodiment of the present invention will be described.

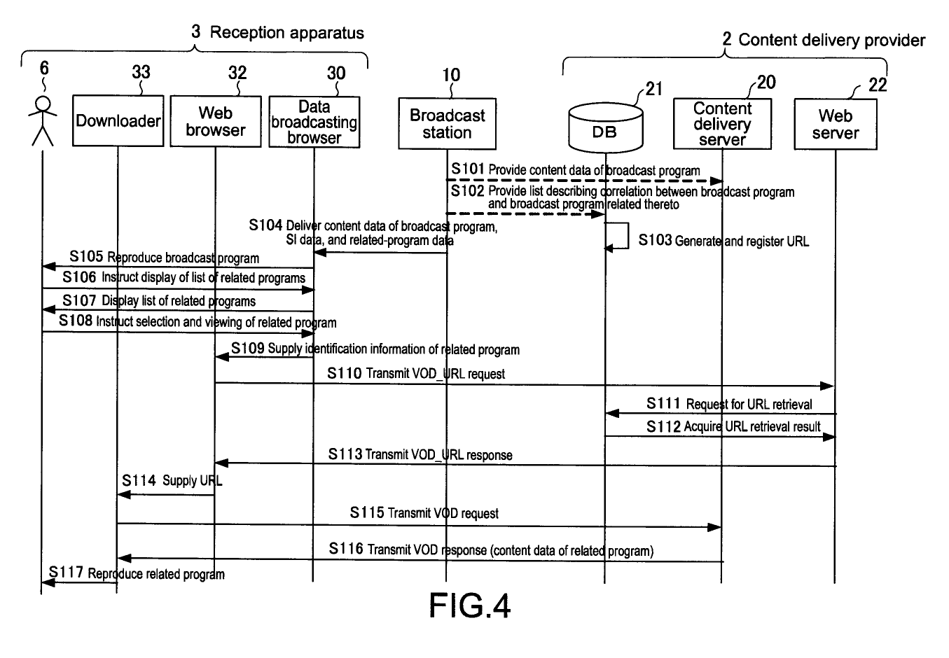

FIG. 4 is a sequence diagram showing a processing flow in the content delivery system 100 according to the first embodiment of the present invention.

The broadcaster 1 provides the content delivery provider 2 with, in addition to content data of a broadcast program for VOD delivery, a list in which correlation between a broadcast program and a broadcast program related thereto (related program) is described based on identification information formed by combination of an event ID and a broadcast date and time of each of the broadcast programs, using a predetermined transmission medium (Step S101, S102). The predetermined transmission medium is, for example, a recording medium or a network, but is not necessary to be particularly defined.

The content delivery provider 2 accumulates the content data of the broadcast program provided by the broadcaster 1 as a content for VOD delivery in the content delivery server 20 and sets a URL for the content data. Then, based on the list provided by the broadcaster 1, the content delivery provider 2 registers the identification information of the broadcast program and the identification information of the broadcast program (related program) related thereto in association with each other in the database (DB) 21, and further registers the set URL in association with the identification information of the broadcast program in the database (DB) 21 (Step S103).

It should be noted that, though the identification information of the broadcast program and the identification information of the broadcast program (related program) related thereto are registered in association with each other in the database (DB) 21 in this embodiment, it may be sufficient to register the identification information of the broadcast program and a URL that specifies a location of content data of the broadcast program (related program) in association with each other.

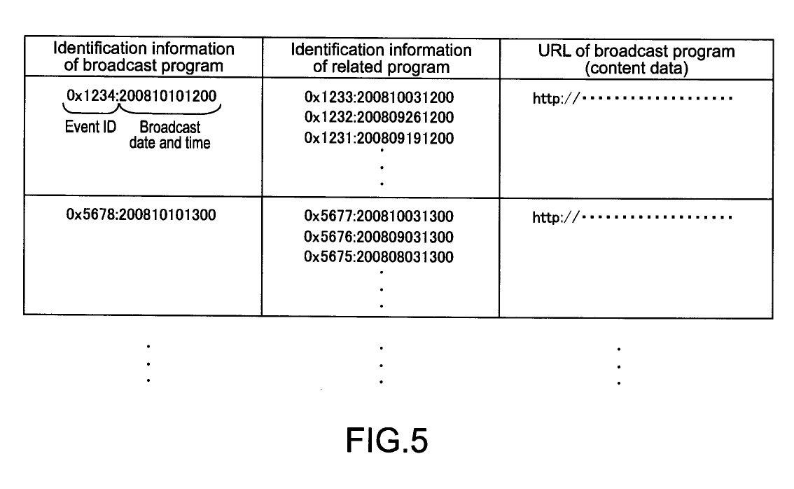

FIG. 5 is a diagram showing an example of information registered in the database (DB) 21. The identification information of a broadcast program is formed of a set of an event ID and a broadcast date and time. The event ID is formed of decimal numbers with a predetermined number of digits, the decimal numbers being assigned by the broadcaster 1, and the broadcast date and time is formed of, for example, data including Christian year, month, day, hour, minute, and the like of a broadcast start. Accordingly, the identification information of a broadcast program becomes unique information for each broadcast program without being bound by the fact that kinds of the event IDs are finite. It should be noted that in a case where the content delivery provider 2 handles contents of broadcast programs provided by a plurality of broadcasters 1, service IDs corresponding to the broadcasters 1 are added.

On the other hand, the broadcast station 10 of the broadcaster 1 broadcasts content data of a broadcast program and also delivers SI data containing information such as a title, an event ID, and a broadcast date and time of the broadcast program, and related-program data such as a title, an event ID, and a broadcast date and time of a broadcast program (related program) related to the aforementioned broadcast program by data broadcasting (Step S104).

The data broadcasting browser 30 of the reception apparatus 3 receives the content data of the broadcast program that is broadcast from the broadcast station 10 and supplies it to the AV player 34. The AV player 34 decodes the content data of the broadcast program. Accordingly, a video of the content is displayed on the display section 108 and an audio thereof is output from the speaker section 107 (Step S105).

During viewing of the broadcast program, when a user 6 uses the remote controller 7 or the input operation section 106 to instruct display of a list of broadcast programs (related programs) related to the broadcast program being viewed (Step S106), the data broadcasting browser 30 performs processing so that the list of broadcast programs (related programs) is displayed based on the related-program data delivered from the broadcast station 10 by data broadcasting (Step S107).

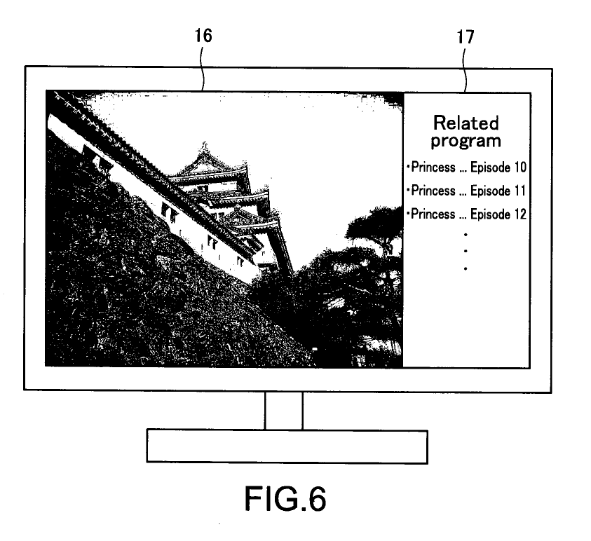

FIG. 6 is a diagram showing a display example of the list of broadcast programs (related programs). FIG. 6 shows a display area 16 of a broadcast program and a display area 17 of the list of broadcast program (related program). Here, a broadcast program that is broadcast as a series is exemplified. As shown in FIG. 6, in the display area 17 of the list displaying the broadcast program (related program), the list of data such as a title contained in the received related-program data is displayed.

In display area 17 of the list displaying the broadcast program (related program) shown in FIG. 6, the user 6 uses the remote controller 7 or the input operation section 106 to input an instruction of selection and viewing of a broadcast program (related program) that the user 6 wishes to view (Step S108). The data broadcasting browser 30 then extracts an event ID and a broadcast date and time of the broadcast program (related program) selected by the user 6 from the related-program data, and supplies identification information formed by combination of the event ID and the broadcast date and time to the web browser 32 (Step S109).

The web browser 32 generates a VOD_URL request containing the identification information of the broadcast program (related program), which is supplied by the data broadcasting browser 30, and transmits the VOD_URL request to the web server 22 of the content delivery provider 2 via the network 4 (Step S110).

When receiving the VOD_URL request, the web server 22 of the content delivery provider 2 requests the database (DB) 21 to retrieve a URL specifying a location of content data of a broadcast program that is registered in association with the identification information contained in the VOD_URL request (Step S111).

When acquiring the retrieval result of the URL from the database (DB) 21 (Step S112), the web server 22 of the content delivery provider 2 generates a VOD_URL response containing the URL and transmits it to the web browser 32 of the reception apparatus 3 via the network 4 (Step S113).

Upon receiving the VOD_URL response, the web browser 32 of the reception apparatus 3 activates the downloader 33 and supplies the URL contained in the VOD_URL response to the downloader 33 (Step S114).

The downloader 33 transmits a VOD request containing the URL acquired from the web browser 32 to the content delivery server 20 of the content delivery provider 2 via the network 4 (Step S115).

When receiving the VOD request containing the URL, the content delivery server 20 of the content delivery provider 2 delivers content data of a broadcast program (related program) specified by the URL contained in the VOD request to the downloader 33 of the reception apparatus 3 via the network 4 (Step S116).

The downloader 33 of the reception apparatus 3 supplies the content data of the broadcast program (related program) delivered by the content delivery server 20 to the AV player 34. The AV player 34 decodes the content data of the broadcast program (related program). Accordingly, a video of the content of the broadcast program (related program) is displayed on the display section 108 and an audio thereof is output from the speaker section 107 (Step S117).

As described above, according to this embodiment, the identification information of the broadcast program is formed by combination of the event ID and the broadcast date and time. Accordingly, even if the kinds of IDs assigned to broadcast programs by a broadcaster are finite, the broadcast programs can be identified using infinite kinds of IDs in a server apparatus and a reception apparatus, with the result that correlation between identification information of a broadcast program that is broadcast and delivered and identification information of a broadcast program that is delivered by VOD can be maintained.

### First Modified Example

Incidentally, in a case where content data of a broadcast program is rebroadcast by the broadcast station 10, the content data itself of the broadcast program to be rebroadcast has already been provided to the content delivery provider 2. Accordingly, in this case, the broadcaster 1 only needs to provide to the content delivery provider 2 a second list in which relationship between the program to be rebroadcast and the broadcast program already provided is described based on identification information formed by combining an event ID and a broadcast date and time of each of the programs.

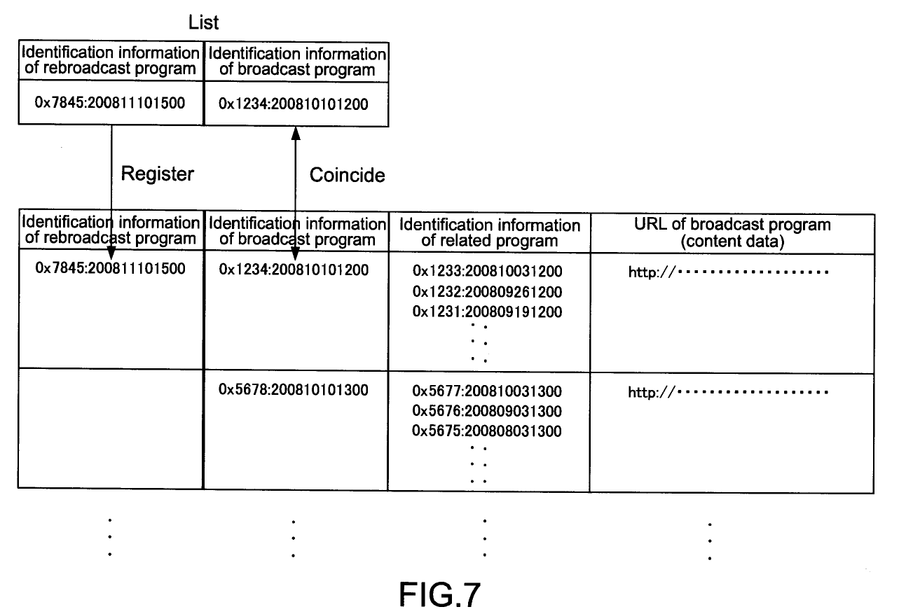

FIG. 7 is a diagram showing an example of information registered in the database (DB) 21, the information being updated based on the second list described above. The content delivery provider 2 retrieves, from the database (DB) 21, a broadcast program whose identification information coincides with the identification information of the already-provided broadcast program shown in the second list provided by the broadcaster 1. Then, the content delivery provider 2 associates identification information of the retrieved broadcast program with the identification information of the rebroadcast program, which is retrieved from the second list, and registers the resultant in the database (DB) 21.

When the web server 22 of the content delivery provider 2 receives a VOD_URL request containing identification information of a broadcast program (related program) from the data broadcasting browser 30, the web server 22 retrieves, from the database (DB) 21, a rebroadcast program or a broadcast program whose identification information coincides with the identification information of the broadcast program (related program) contained in the VOD_URL request. When an appropriate rebroadcast program is retrieved, the web server 22 determines a broadcast program associated with the rebroadcast program in the database (DB) 21 and retrieves a URL registered in the database (DB) 21 in association with the broadcast program. Further, when an appropriate broadcast program is retrieved, it is only necessary to retrieve a URL registered in the database (DB) 21 in association with the broadcast program.

### Second Embodiment

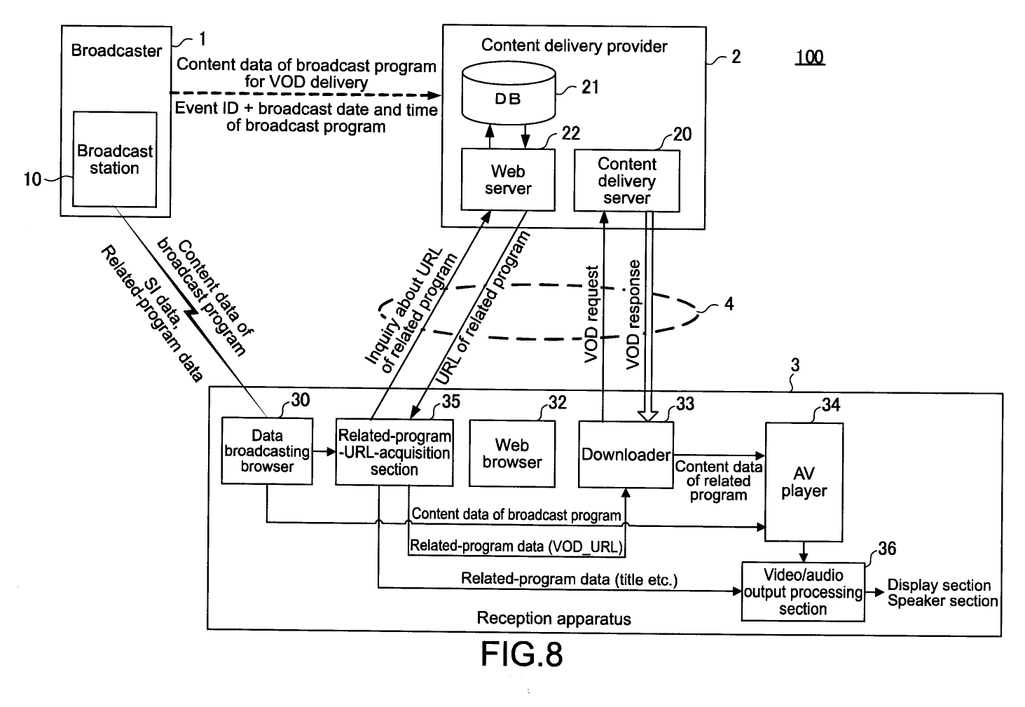

FIG. 8 is a diagram showing a structure of the content delivery system 100 according to a second embodiment of the present invention.

The content delivery system 100 according to the second embodiment differs from the first embodiment in the structure of the reception apparatus 3.

The reception apparatus 3 includes a related-program-URL-acquisition section 35 that operates in cooperation with the data broadcasting browser 30. When an instruction to display a list of broadcast programs (related programs) is given by the user 6 during reception of content data of a broadcast program, the related-program-URL-acquisition section 35 performs processing so that the list of the broadcast programs (related programs) is displayed based on the related-program data delivered by the broadcast station 10 by data broadcasting. On the other hand, the related-program-URL-acquisition section 35 extracts an event ID and a broadcast date and time of the broadcast program being received, from the SI data delivered by the broadcast station 10 by data broadcasting, and transmits a related-program-URL-request containing identification information formed by combination of the event ID and the broadcast date and time to the web server 22 of the content delivery provider 2. Accordingly, a URL specifying a location of a broadcast program (related program) related to the broadcast program being received is acquired from the web server 22. The related-program-URL-acquisition section 35 supplies, out of URLs of the broadcast programs (related programs) acquired from the web server 22, a URL of a broadcast program (related program) selected from the list of the broadcast programs (related programs) so as to be viewed by the user 6, to the downloader 33, causes the downloader 33 to download content data of the broadcast program (related program), and supplies the content data to the AV player 34.

It should be noted that the broadcast station 10 of the broadcaster 1, and the content delivery server 20, the database (DB) 21, and web server 22 of the content delivery provider 2 are the same as in the first embodiment except a portion cooperating with the related-program-URL-acquisition section 35.

(Description of Operation)

Next, an operation of the content delivery system 100 according to the second embodiment of the present invention will be described.

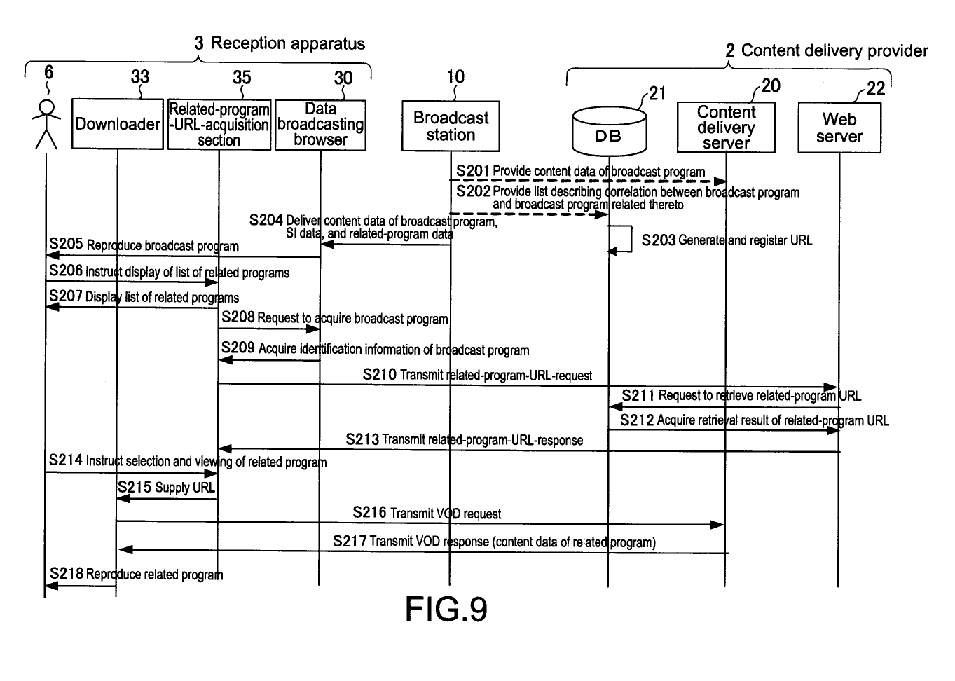

FIG. 9 is a sequence diagram showing a processing flow in the content delivery system 100 according to the second embodiment of the present invention.

The broadcaster 1 provides the content delivery provider 2 with, in addition to content data of a broadcast program for VOD delivery, a list in which correlation between a broadcast program and a broadcast program related thereto (related program) is described based on identification information formed by combination of an event ID and a broadcast date and time of each of the broadcast programs, using a predetermined transmission medium (Step S201, S202).

The content delivery provider 2 accumulates the content data of the broadcast program provided by the broadcaster 1 as a content for VOD delivery in the content delivery server 20 and sets a URL for the content data. Then, based on the list provided by the broadcaster 1, the content delivery provider 2 registers identification information of the broadcast program and identification information of the broadcast program (related program) related thereto in association with each other in the database (DB) 21, and further registers the set URL in association with the identification information of the broadcast program in the database (DB) 21 (Step S203).

On the other hand, the broadcast station 10 of the broadcaster 1 broadcasts content data of a broadcast program and also delivers SI data containing information such as a title, an event ID, and a broadcast date and time of the broadcast program, and related-program data such as a title, an event ID, and a broadcast date and time of the broadcast program (related program) related to the aforementioned broadcast program by data broadcasting (Step S204).

The data broadcasting browser 30 of the reception apparatus 3 receives the content data of the broadcast program that is broadcast from the broadcast station 10 and supplies it to the AV player 34. The AV player 34 decodes the content data of the broadcast program. Accordingly, a video of the content is displayed on the display section 108 and an audio thereof is output from the speaker section 107 (Step S205). The processing up to here is the same as in the first embodiment.

During viewing of the broadcast program, when the user 6 uses the remote controller 7 or the input operation section 106 to instruct display of a list of broadcast programs (related programs) related to the broadcast program being viewed (Step S206), the related-program-URL-acquisition section 35 is activated.

The related-program-URL-acquisition section 35 performs processing so that the list of the broadcast programs (related programs) is displayed using information such as a title contained in the related-program data delivered by the broadcast station 10 by data broadcasting (Step S207).

On the other hand, the related-program-URL-acquisition section 35 extracts an event ID and a broadcast date and time of the broadcast program being viewed, from the SI data acquired by the data broadcasting browser 30 (Step S208, S209), and transmits a related-program-URL-request containing identification information formed by combination of the event ID and the broadcast date and time to the web server 22 of the content delivery provider 2 (Step S210).

Upon receiving the related-program-URL-request transmitted from the related-program-URL-acquisition section 35 of the reception apparatus 3, the web server 22 of the content delivery provider 2 request the database (DB) 21 to retrieve a URL specifying a location of a broadcast program (related program) associated with the broadcast program, based on the identification information of the broadcast program, which is contained in the related-program-URL-request (Step S211). In accordance with the retrieval request, the database (DB) 21 retrieves identification information of the broadcast program (related program) associated with the broadcast program and the URL specifying the location of the broadcast program (related program), and responds to the web server 22 together with the identification information of the broadcast program (related program) (Step S212).

When acquiring the URL specifying the location of the broadcast program (related program) and the identification information thereof from the database (DB) 21, the web server 22 transmits them to the related-program-URL-acquisition section 35 of the reception apparatus 3 as a related-program-URL-response (Step S213).

When receiving the related-program-URL-response from the web server 22, the related-program-URL-acquisition section 35 of the reception apparatus 3 verifies the identification information contained in the related-program-URL-response and combination of an event ID and a broadcast date and time of each broadcast program (related program) in the related-program data, and then links each broadcast program (related program) in the displayed list of the broadcast programs (related programs) with the related-program-URL-response.

After that, in the list of the broadcast programs (related programs), it is assumed that the user 6 uses the remote controller 7 or the input operation section 106 to input an instruction of selection and viewing of a broadcast program (related program) that the user 6 wishes to view (Step S214). The related-program-URL-acquisition section 35 then supplies to the downloader 33 a URL contained in the related-program-URL-response that is associated with the selected broadcast program (related program) (Step S215).

The downloader 33 transmits a VOD request containing the URL to the content delivery server 20 of the content delivery provider 2 via the network 4 (Step S216).

When receiving the VOD request containing the URL, the content delivery server 20 of the content delivery provider 2 delivers content data of the broadcast program (related program) specified by the URL contained in the VOD request to the downloader 33 of the reception apparatus 3 via the network 4 (Step S217).

The downloader 33 of the reception apparatus 3 supplies the content data of the broadcast program (related program) delivered by the content delivery server 20 to the AV player 34. The AV player 34 decodes the content data of the broadcast program (related program). Accordingly, a video of the content of the broadcast program (related program) is displayed on the display section 108 and an audio thereof is output from the speaker section 107 (Step S218).

As described above, according to this embodiment as well, even if the kinds of IDs assigned to broadcast programs by a broadcaster are finite, the broadcast programs can be identified using infinite kinds of IDs in a server apparatus and a reception apparatus, with the result that correlation between identification information of a broadcast program that is broadcast and delivered and identification information of a broadcast program that is delivered by VOD can be maintained.

### Second Modified Example

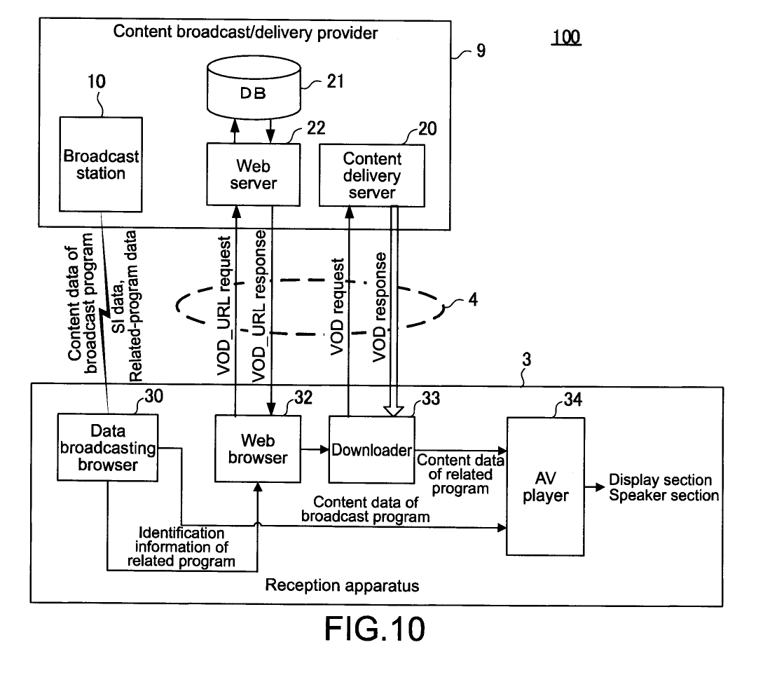

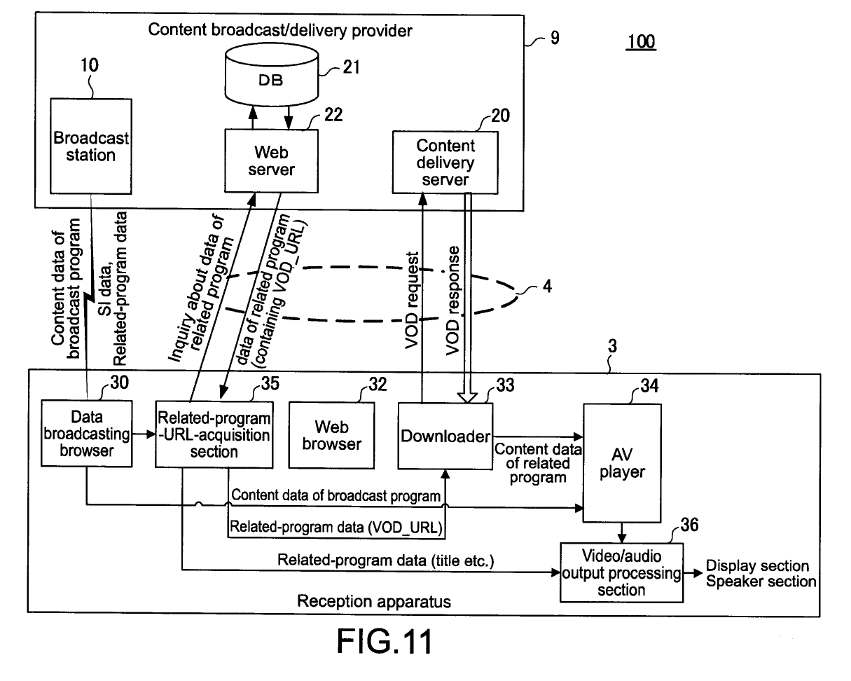

The system of the case where the broadcaster 1 and the content delivery provider 2 are separately present has been described so far. However, as shown in FIGS. 10 and 11, the present invention is applicable to a case where the broadcaster 1 and the content delivery provider 2 are present as a single content broadcaster/delivery provider 9.

### Third Modified Example

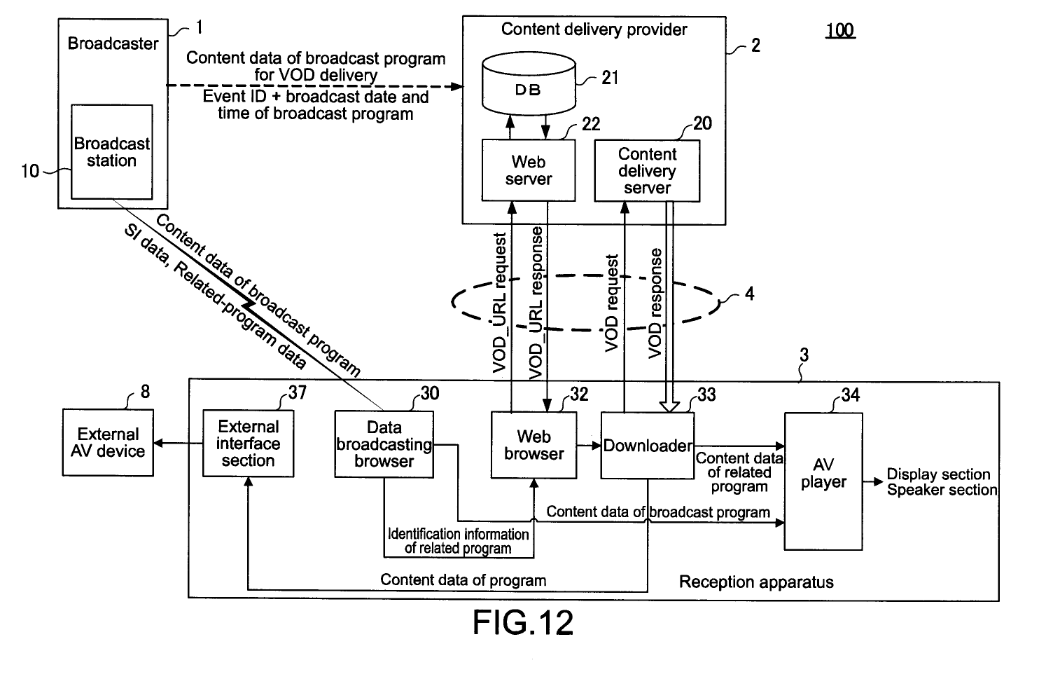

FIG. 12 is a diagram showing a modified example of the reception apparatus 3 of the first embodiment.

The reception apparatus 3 of this modified example includes an external interface section 37. The external interface section 37 transfers content data of a broadcast program received by the data broadcasting browser 30 and content data of a broadcast program downloaded from the content delivery server 20 by the downloader 33 to an external AV device 8 connected to the reception apparatus 3. Accordingly, the content data of the broadcast program can be taken out and reproduced in the external AV device 8.

Further, in order to accumulate content data of broadcast programs, a data record section may be provided to the reception apparatus 3, the data record section including a hard disc drive and an optical disc drive performing read and write with respect to a recording medium such as a DVD (Digital Versatile Disc), a Blu-ray disc, and the like.

Further, in the embodiments described above, the system in which a broadcast program that is broadcast and delivered by airwaves is received by the reception apparatus 3 has been described. However, the present invention is also applicable to a case where a broadcast program that is broadcast and delivered by IP multicast is received.

The present application contains subject matter related to that disclosed in Japanese Priority Patent Application JP 2008-262003 filed in the Japan Patent Office on Oct. 8, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reception apparatus, comprising:
an acquisition section to acquire program information containing an ID that is assigned to a broadcast program by a broadcaster and a broadcast date and time; and
a transmission section to transmit, to a server apparatus that manages the broadcast program using identification information formed by combination of the ID and the broadcast date and time, a request containing the identification information formed by combination of the ID and the broadcast date and time that are contained in the program information.

2. The reception apparatus according to claim 1, further comprising
a selection section to cause a user to select a broadcast program as a request target based on the program information;
wherein the transmission section takes out the ID and the broadcast date and time of the selected broadcast program from the program information and transmits to the server apparatus a request containing the identification information formed by combination of the ID and the broadcast date and time.

3. The reception apparatus according to claim 2,
wherein the transmission section transmits, to the server apparatus, the request for acquiring information that specifies content data of the selected broadcast program.

4. The reception apparatus according to claim 1,
wherein the transmission section transmits, to the server apparatus, the request for specifying content data of a program related to a broadcast program being received.

5. A reception method, comprising:
acquiring program information containing an ID that is assigned to a broadcast program by a broadcaster and a broadcast date and time; and
transmitting, to a server apparatus that manages the broadcast program using identification information formed by combination of the ID and the broadcast date and time, a request containing the identification information formed by combination of the ID and the broadcast date and time that are contained in the program information.

6. A server apparatus, comprising:
a database section to register identification information that identifies a broadcast program and program-data specific information that specifies content data of the broadcast program in association with each other, the identification information being formed by combination of an ID that is assigned to the broadcast program by a broadcaster and a broadcast date and time; and
a request processing section to retrieve, when a request containing the identification information is received from a reception apparatus, the program-data specific information associated with the identification information contained in the request from the database section, and returns the program-data specific information to the reception apparatus.

7. A server apparatus, comprising:
a database section to register first identification information that identifies a broadcast program, second identification information that identifies a broadcast program related to the broadcast program as a related program, and program-data specific information that specifies content data of the broadcast program in association with one another, the first identification information being formed by combination of an ID that is assigned by a broadcaster to the broadcast program and a broadcast date and time, the second identification information being formed by combination of an ID that is assigned by the broadcaster to the related program and a broadcast date and time; and
a request processing section to retrieve, when a request containing the first identification information of the broadcast program is received from a reception apparatus, the second identification information of the related program from the database section, the second identification information being associated with the first identification information contained in the request, retrieves the broadcast program whose first identification information coincides with the retrieved second identification information, and returns the program-data specific information associated with the broadcast program to the reception apparatus.
